(19) United States
(12) Patent Application Publication
(10) Pub. No.: US 2013/0254265 A1
(43) Pub. Date: Sep. 26, 2013

(54) SYSTEM AND MECHANISMS FOR TRANSFERRING USER SELECTED CONTENT TO A RECIPIENT

(71) Applicant: Alexandra Chemla, New York, NY (US)

(72) Inventor: Alexandra Chemla, New York, NY (US)

(21) Appl. No.: 13/847,949

(22) Filed: Mar. 20, 2013

Related U.S. Application Data
(60) Provisional application No. 61/698,493, filed on Sep. 7, 2012.
(60) Provisional application No. 61/685,531, filed on Mar. 20, 2012.

(51) Int. Cl. H04L 29/08

(52) U.S. Cl. CPC H04L 67/10
USPC 709/203

(57) ABSTRACT

In accordance with an implementation of the present application, a non-transitory computer-readable storage medium is provided that stores instructions executable by a computing device, the non-transitory computer-readable storage medium comprising instructions to receive an inventory listing generated by a local computing system for a plurality of visual works, wherein the inventory listing includes information for each individual visual work included in the plurality of visual works and one or more images of each individual work. Further, a selection is received of at least a portion of the plurality of the visual works and information for each individual work for inclusion in a displayable compilation of the selected portion of the plurality of the visual works.

### CROSS-REFERENCE TO RELATED APPLICATION

The present application claims the benefit of U.S. patent application Ser. No. 61/685,531, filed Mar. 20, 2012, and U.S. patent application Ser. No. 61/698,493, filed Sep. 7, 2012, both of which are hereby incorporated by reference in their entirety.

### FIELD

This invention relates generally to image content, and more particularly to a system and method for archive and display of content.

### SUMMARY

In accordance with an implementation of the present application, a non-transitory computer-readable storage medium is provided that stores instructions executable by a computing device, the non-transitory computer-readable storage medium comprising instructions to receive an inventory listing generated by a local computing system for a plurality of visual works, wherein the inventory listing includes information for each individual visual work included in the plurality of visual works and one or more images of each individual work. Further, a selection is received of at least a portion of the plurality of the visual works and information for each individual work for inclusion in a displayable compilation of the selected portion of the plurality of the visual works. The displayable compilation is published to enable the displayable compilation to be presented on one or more selected portable computing devices remote from the server computing system. The inventory listing may be in the form of a spreadsheet exportable from a visual works inventory management system. In addition or in the alternative, the information representing each individual visual work included in the plurality of visual works may include a name of an artist creating each individual visual work, a title of each individual visual work, and an inventory identifier of each individual visual work.

In addition or in the alternative, the information representing the plurality of visual works may include for each individual visual work one or more of dimensions of each individual visual work, a year of creation of each individual visual work, a price of each individual visual work, and an availability for purchase of each individual visual work. Further, supplementary information may to be associated with one or more of each of the plurality of visual works. The supplementary information may include one or more of biographical information of the artist creating one or more of the plurality of visual works and press information relating to one of the artists and one or more of the plurality of visual works. Furthermore, a search of the inventory listing may be implemented by one or more parameters to facilitate the selection of the at least a portion of the plurality of the visual works and the information for each individual work for inclusion in a displayable compilation.

In addition or in the alternative, information may be received representing the plurality of visual works, enabling verification of the information representing the plurality of visual works. The inventory listing may be secured to a particular account, wherein the server computing system may maintain a plurality of inventory listings for a plurality of accounts, and wherein only a user authenticated to access the inventory listing of the particular account is enabled access to the inventory listing of the particular account. A command may be received to delete the displayable compilation while maintaining the displayable compilation on the server computing system for subsequent publication. The server computing system may be accessible via an Internet using a uniform resource locator.

In addition, or in the alternative, displayable compilation may be accessed that is published for access by one or more portable computing systems at a server computing system, wherein the displayable compilation includes information for each individual visual work included in the displayable compilation and one or more images of each individual visual work included in the displayable compilation; and selectively displaying the information for each individual work included in the displayable compilation. In one or more implementations, only an authorized user may enter commands enabling the selective display of information, wherein other users are able to access the information selectively enabled for display by the authorized user. The selective display of information may be enabled by the authorized user and may include one of displaying and suppressing a price of each individual visual work included in the displayable compilation. Further, a search of the displayable compilation according to one or more parameters relating to one or more individual visual works included in the displayable compilation.

These and other aspects, features, and advantages of the invention can be understood with reference to the following detailed description of certain embodiments of the invention taken together in conjunction with the accompanying drawing figures.

### BRIEF DESCRIPTION OF THE DRAWINGS

FIG. 1 is a diagram of an example hardware arrangement that operates for providing the systems and methods disclosed herein;

FIG. 2 illustrates functional elements of each information processor or workstation;

FIGS. 3A-3F illustrate example display screens in accordance with an embodiment of the present application;

FIGS. 4 and 4A illustrate an example mobile computing device (e.g., a tablet computer) and further illustrate example display screens provided in accordance with an embodiment of the present application; and

FIGS. 5-23 illustrate an example mobile computing device (e.g., a tablet computer) and further illustrate example display screens provided in accordance with an embodiment of the present application.

### DESCRIPTION

The present application provides a solution for reviewing, ordering and receiving artwork, and is particularly adapted for mobile computing devices, such as tablet computing devices, smartphones, personal digital assistants or the like. In an embodiment, a system and method is provided for offering art galleries a new way to display a curated selection of their works. Intuitive tools are provided that enable mobile computing devices to streamline sales and presentation of artwork that previously required physical binders of content, such as displayed in connection with a public event (e.g., an art fair) and that often included significant shipping fees, large and expensive booths, and the like. The solution set forth in accordance with the present application provides an opportunity for improved sales opportunities, as well as significant time and cost savings as a function of a multimedia tool that provides access to content and information remotely and efficiently. The teachings herein provide access to artwork and corresponding information in many different contexts, including art fairs and sales meetings, offices, and a wide variety of public venues, such as restaurants and shops, to facilitate convenient locations where potential and existing clients may want to meet.

As used herein, the term, “module,” refers, generally, to one or more discrete components that contribute to the effectiveness of the present invention. Modules can include software elements, including but not limited to functions, algorithms, classes and the like. Modules also include hardware elements, substantially as described below. Modules can operate independently or, alternatively, depend upon one or more other modules in order to function.

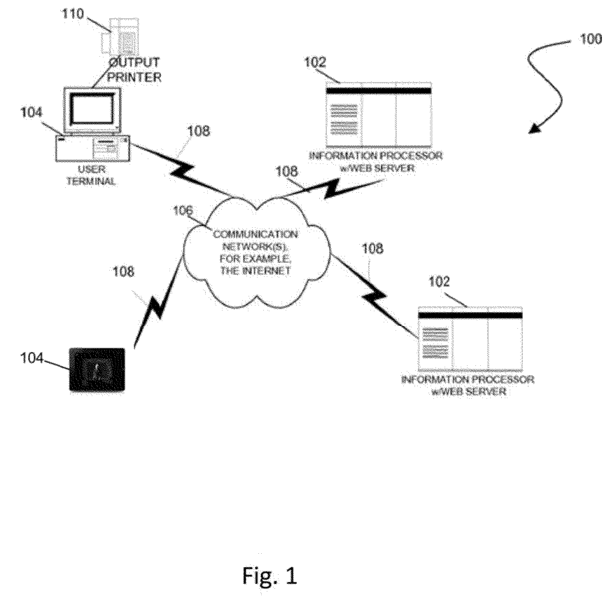

Referring now to the drawings figures in which like reference numerals refer to like elements, there is shown in FIG. 1 a diagram of an example hardware arrangement that operates for providing the systems and methods disclosed herein, and designated generally as system 100. System 100 is preferably comprised of one or more information processors 102 coupled to one or more user workstations 104 across communication network 106. User workstations may include, for example, mobile computing devices such as tablet computing devices, smartphones, personal digital assistants or the like. Further, printed output may be provided, for example, via output printers 110.

Information processor 102 preferably includes all necessary databases for the present invention, including image files, metadata and other information relating to artwork, artists, and galleries. However, it is contemplated that information processor 102 can access any required databases via communication network 106 or any other communication network to which information processor 102 has access. Information processor 102 can communicate devices comprising databases using any known communication method, including a direct serial, parallel, USB interface, or via a local or wide area network.

User workstations 104 communicate with information processors 102 using data connections 108, which are respectively coupled to communication network 106. Communication network 106 can be any communication network, but is typically the Internet or some other global computer network. Data connections 108 can be any known arrangement for accessing communication network 106, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User workstations 104 preferably have the ability to send and receive data across communication network 106, and are equipped with web browsers to display the received data on display devices incorporated therewith. By way of example, user workstation 104 may be personal computers such as Intel Pentium-class computers or Apple Macintosh computers, but are not limited to such computers. Other workstations which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 106. Of course, one skilled in the art will recognize that wireless devices can communicate with information processors 102 using wireless data communication connections (e.g., Wi-Fi).

According to an embodiment of the present application, user workstation 104 provides user access to information processor 102 for the purpose of receiving and providing art-related information. The specific functionality provided by system 100, and in particular information processors 102, is described in detail below.

System 100 preferably includes software that provides functionality described in greater detail herein, and preferably resides on one or more information processors 102 and/or user workstations 104. One of the functions performed by information processor 102 is that of operating as a web server and/or a web site host. Information processors 102 typically communicate with communication network 106 across a permanent i.e., unswitched data connection 108. Permanent connectivity ensures that access to information processors 102 is always available.

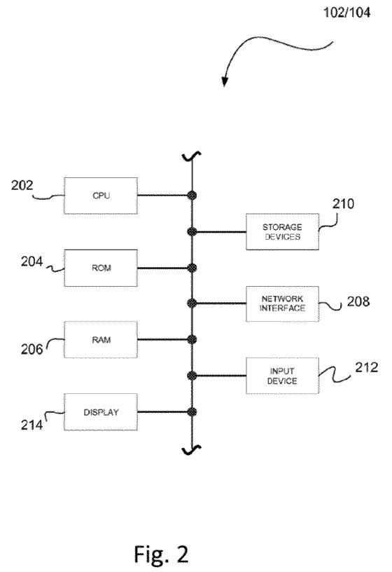

As shown in FIG. 2 the functional elements of each information processor 102 or workstation 104, and preferably include one or more central processing units (CPU) 202 used to execute software code in order to control the operation of information processor 102, read only memory (ROM) 204, random access memory (RAM) 206, one or more network interfaces 208 to transmit and receive data to and from other computing devices across a communication network, storage devices 210 such as a hard disk drive, floppy disk drive, tape drive, CD-ROM or DVD drive for storing program code, databases and application code, one or more input devices 212 such as a keyboard, mouse, track ball and the like, and a display 214.

The various components of information processor 102 need not be physically contained within the same chassis or even located in a single location. For example, as explained above with respect to databases which can reside on storage device 210, storage device 210 may be located at a site which is remote from the remaining elements of information processors 102, and may even be connected to CPU 202 across communication network 106 via network interface 208.

The functional elements shown in FIG. 2 (designated by reference numbers 202-214) are preferably the same categories of functional elements preferably present in user workstation 104. However, not all elements need be present, for example, storage devices in the case of PDAs, and the capacities of the various elements are arranged to accommodate expected user demand. For example, CPU 202 in user workstation 104 may be of a smaller capacity than CPU 202 as present in information processor 102. Similarly, it is likely that information processor 102 will include storage devices 210 of a much higher capacity than storage devices 210 present in work station 104. Of course, one of ordinary skill in the art will understand that the capacities of the functional elements can be adjusted as needed.

The nature of the present application is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, IOS, ANDROID, TORR and various web application development environments.

As used herein, references to displaying data on user workstation 104 refer to the process of communicating data to the workstation across communication network 106 and processing the data such that the data can be viewed on the user workstation 104 display 214 using a web browser or the like. The display screens on user workstation 104 present areas within control allocation system 100 such that a user can proceed from area to area within the control allocation system 100 by selecting a desired link. Therefore, each user's experience with control allocation system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of control allocation system 100.

Although the present application is described by way of example herein in terms of a web-based system using web browsers and a web site server (information processor 102), and with mobile computing devices (104) system 100 is not limited to that particular configuration. It is contemplated that control allocation system 100 can be arranged such that user workstation 104 can communicate with, and display data received from, information processor 102 using any known communication and display method, for example, using a non-Internet browser Windows viewer coupled with a local area network protocol such as the Internetwork Packet Exchange (IPX). It is further contemplated that any suitable operating system can be used on user workstation 104, for example, WINDOWS 3.X, WINDOWS 95, WINDOWS 98, WINDOWS 2000, WINDOWS CE, WINDOWS NT, WINDOWS XP, WINDOWS VISTA, WINDOWS 2000, WINDOWS XP, WINDOWS 7, MAC OS, LINUX, IOS, ANDROID and any suitable mobile device operating system.

In accordance with an embodiment, a gallery or other organization uploads content, such as image files and information associated therewith, to information processor 102. When first uploaded, images and content may be suitably formatted to comply with one or more display criteria associated with mobile computing devices. Content may be provided on a mobile computing device, such as an IPAD, and in a preconfigured application, or may be provided in a standard web browser-based environment.

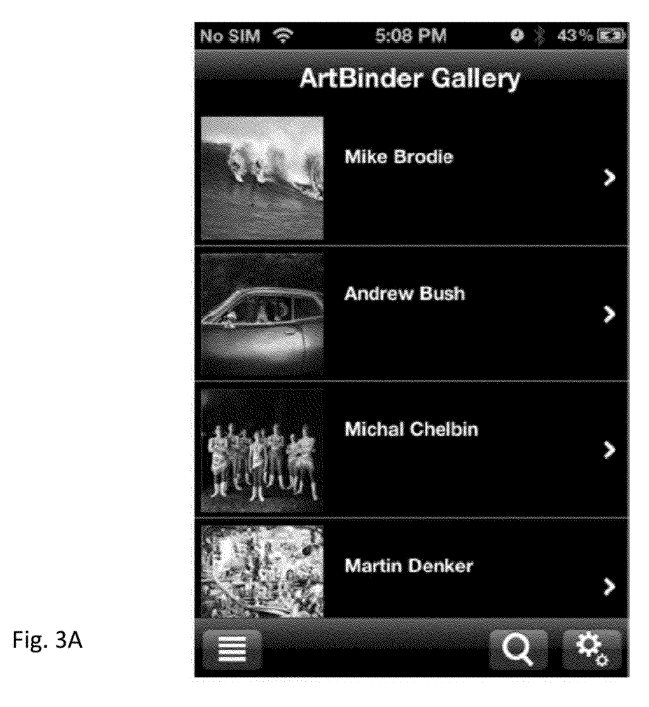

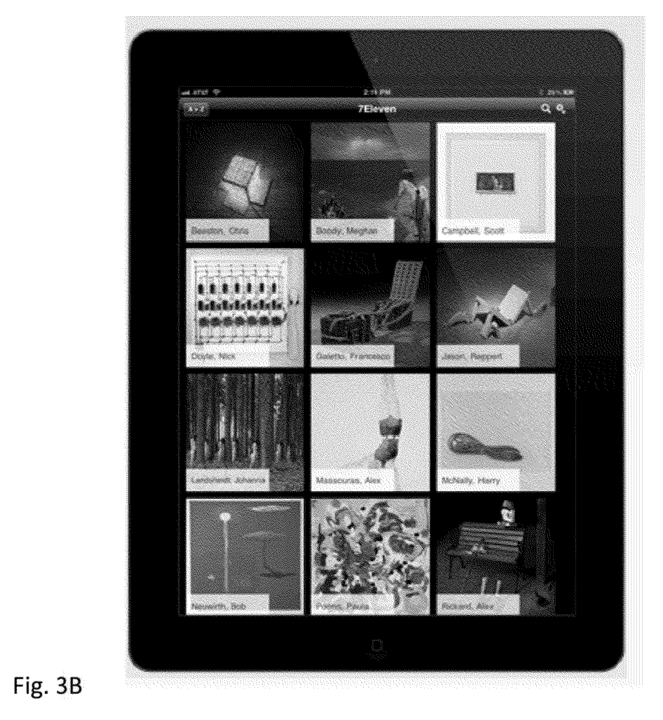

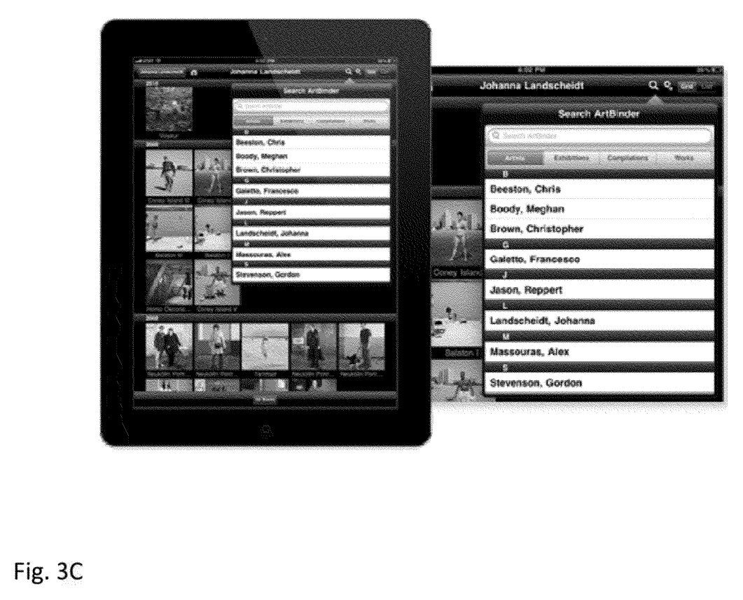

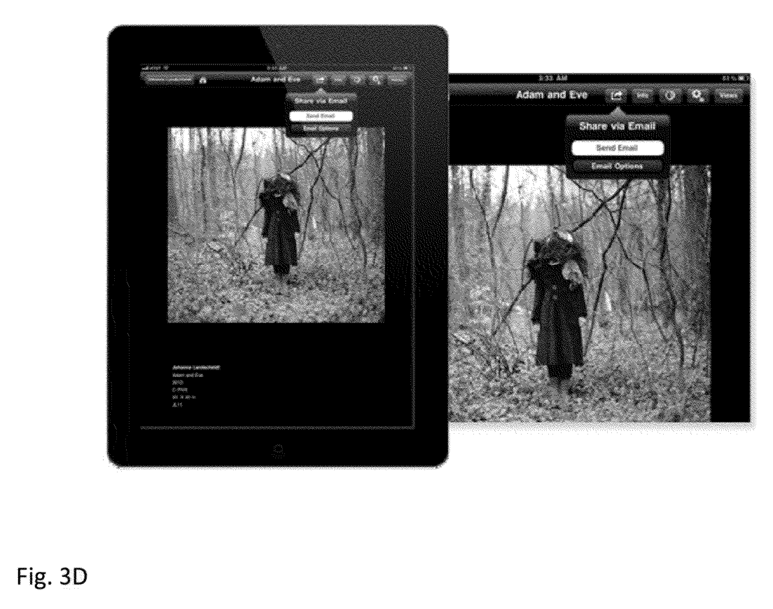

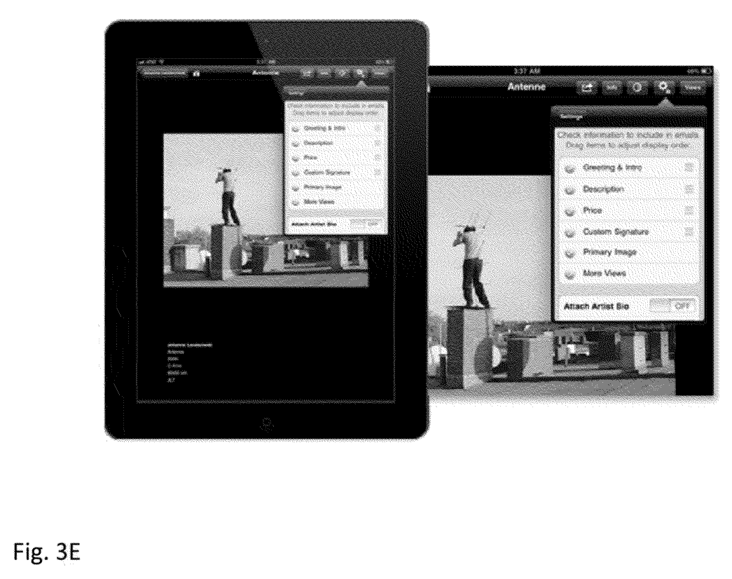

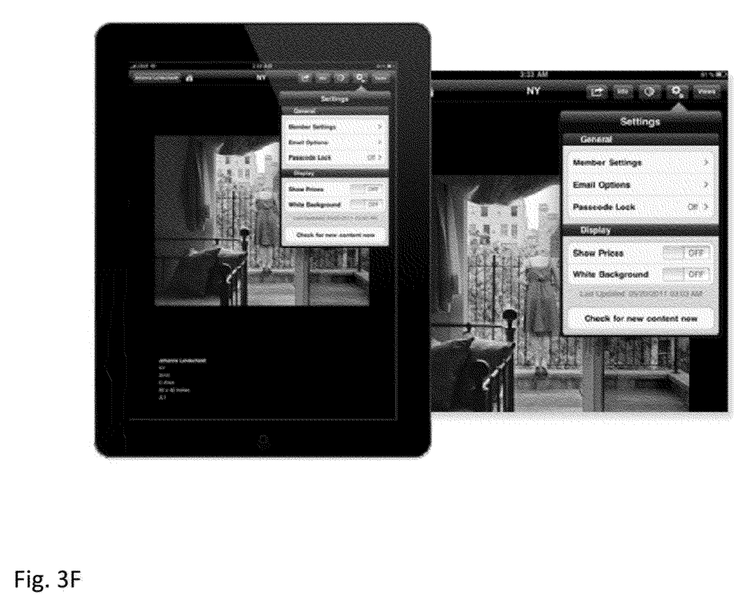

FIGS. 3A and 3B illustrate example display screens in accordance with an embodiment of the present application. The examples shown in FIGS. 3A and 3B illustrate an easy-to-use, intuitive user interface that supports convenient navigation and clear organization. As illustrated in FIG. 3A, a “Home Screen” is featured that includes a sleek, easy to navigate grid of artists that are represented by a particular gallery. In the embodiment shown in FIG. 3A, artists are arranged alphabetically and corresponding thumbnails are included, and are searchable by name, work, or exhibition. Tapping on an individual artist's thumbnail leads the viewer to a dedicated artist page, which may include various sections, such as works, exhibitions, compilations, biography and press. The works and exhibitions sections may be arranged chronologically, may be displayed as thumbnail images or as a list, and can be customized according to each art dealer's specifications. For example, multiple screen views can be shown of each art piece. The compilations section may also provide a space for art dealers to create purpose-specific groupings (for example, a compilation of all of the works that might interest a particular client). Furthermore, the biography and press pages consist of uploaded ADOBE PDF files that can be easily viewed, searched, or emailed.

FIG. 3C illustrates an example display screen in accordance with an embodiment of the present application, and includes a search feature allows the user to search the application using criteria such as by artist, work and exhibition.

FIG. 3D illustrates an example display screen in accordance with an embodiment of the present application, and provides for sending follow-up messages, such as emails, on the go. As illustrated in the example shown in FIG. 3D, users can email images and details of individual works directly from their mobile computing devices. As illustrated in FIG. 3E, customizable settings are provided to enable users to quickly and easily select particular kinds of information to be included with an image. For example, information associated with provenance, price, dimensions, or the like can be selected, and in a particular display order. With just a few taps, a user can easily send an email with images and any selection of work details. Users can also create a customizable signature and attach PDFs of bios or press reviews.

With reference to FIG. 3F, one or more toggle features are provided to allow users to turn various displays, such as for price display, on or off, as well as to show image(s) without any accompanying text information. In an embodiment, another option (“more views”) is provided to offer various images and viewpoints of each art piece, including installation views and different angles. Moreover, the system and method herein is operable with native operating systems, such as the IPAD's easy zoom feature that allows users to see closer details.

In an embodiment, content that is stored on one or more computers, such as servers, is provided wirelessly through a Wi-Fi update feature. Users may retrieve images from a gallery's database at a moment's notice.

Moreover, the present application is compliant and compatible with known inventory management and database software applications, such as FILEMAKER, ARTLOGIC, ARTBASE, and ARTSYSTEMS. This solution was created to address challenges faced by galleries trying to input and store information on mobile devices, such as IPADs. Rather than spending endless hours inputting information manually, the present application is configurable in only a few simple steps. In an embodiment, the user uploads a file, such as a delimited file or CSV file representing a gallery inventory; as she adds images, whether all at once or in several increments, each image is paired with its respective work details. In an embodiment, images, text, and other data (“imported content”) is imported, and is encrypted using an SSL connection and stored on third party servers.

In an embodiment, a selection of images is provided for view, review and/or editing. Referred to herein, generally, as a “packet,” a selection of images or other artwork may be made via a computing device by a user of the present application. Accordingly, a presentation-based system and method is provided in which a layout is provided.

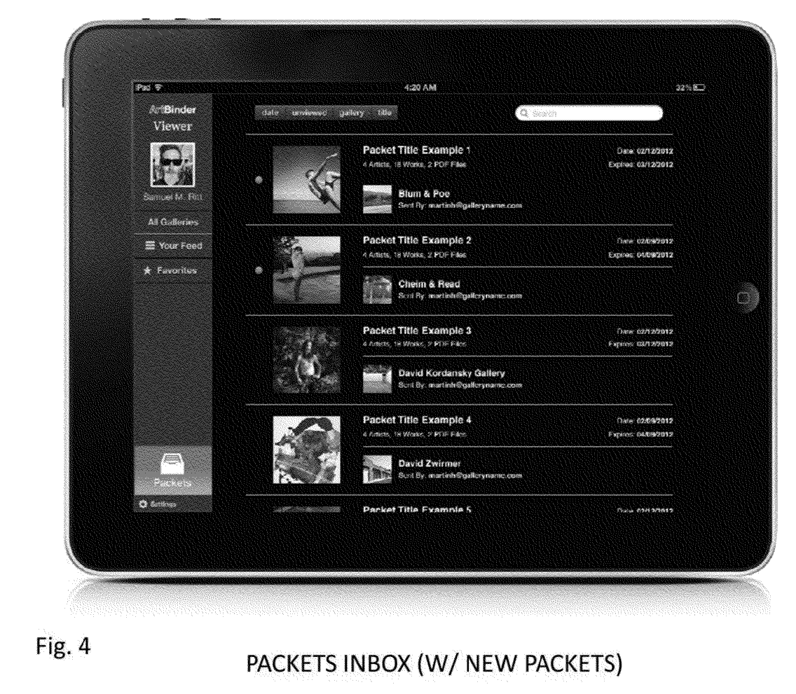

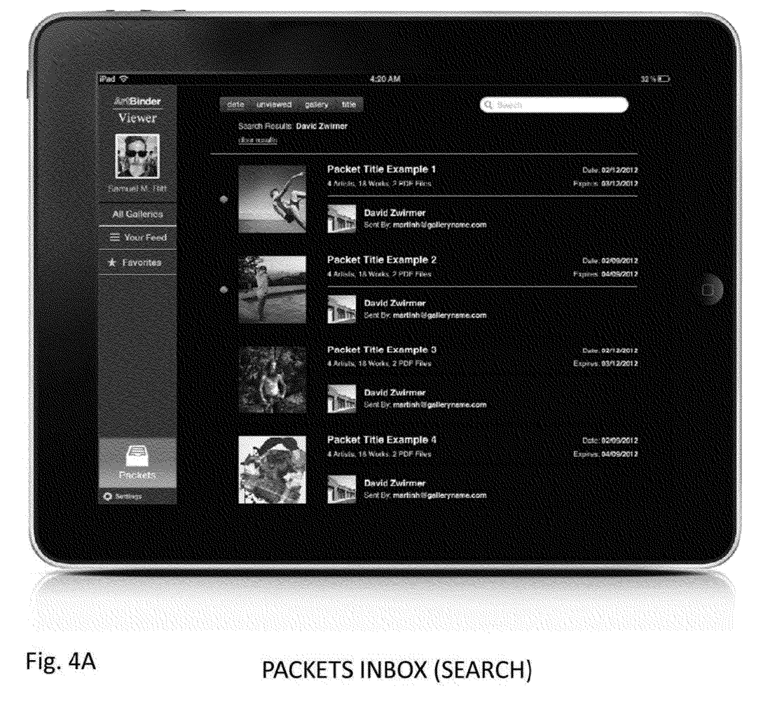

FIGS. 4 and 4A illustrate an example mobile computing device (e.g., a tablet computer) and further illustrate example display screens provided in accordance with an embodiment of the present application. The examples shown in FIGS. 4 and 4A illustrate an example packets inbox (w/new packets). The packets in the reference figures illustrate collections of material from one or more artists, one or more corresponding information files, thumbnails, and identifies a sender (e.g., an email address). FIG. 4A illustrates a mobile computing device and illustrates search functionality associated with a plurality of packets in an inbox.

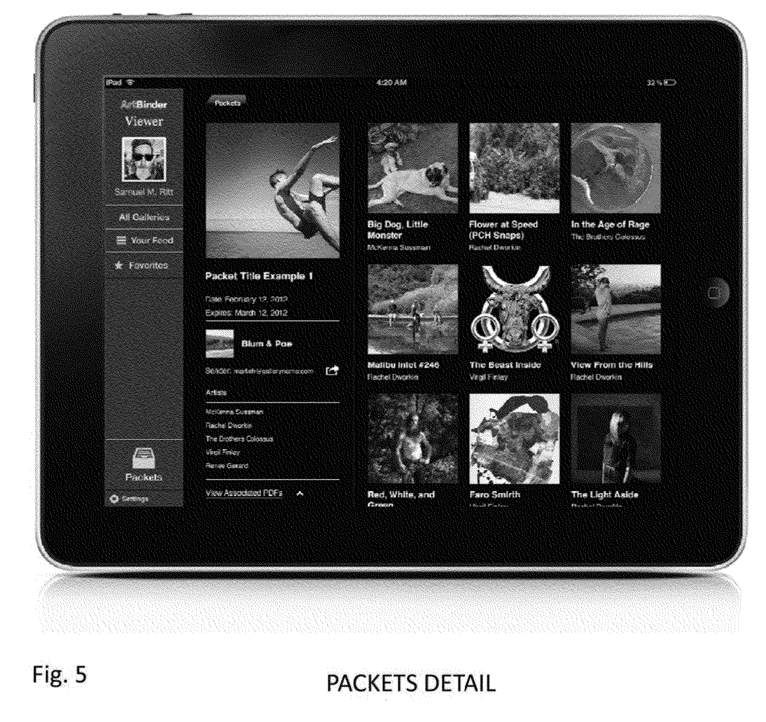

FIG. 5 illustrates an example mobile computing device (e.g., a tablet computer) and an example display screen provided in accordance with an embodiment of the present application. The example shown in FIG. 5 illustrates details associated with an example packet. Detail examples include packet title, current date, expiration date (for accessing the packet), sending party, artists, associated information file(s) (e.g., PDF), and the like.

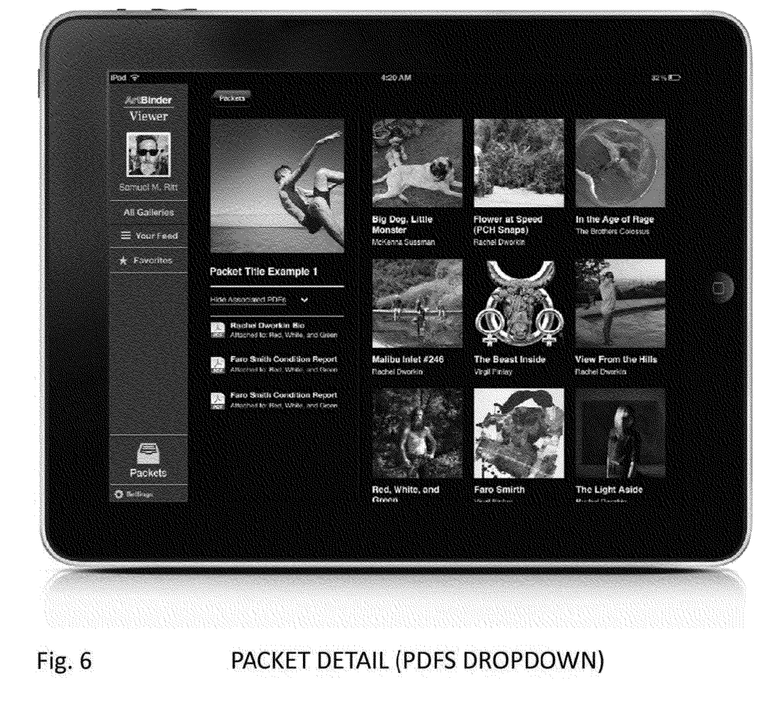

FIG. 6 illustrates an example mobile computing device (e.g., a tablet computer) and an example display screen provided in accordance with an embodiment of the present application. The example shown in FIG. 6 illustrates functionality associated with identifying a plurality of information files (e.g., PDF files), and available via a dropdown list.

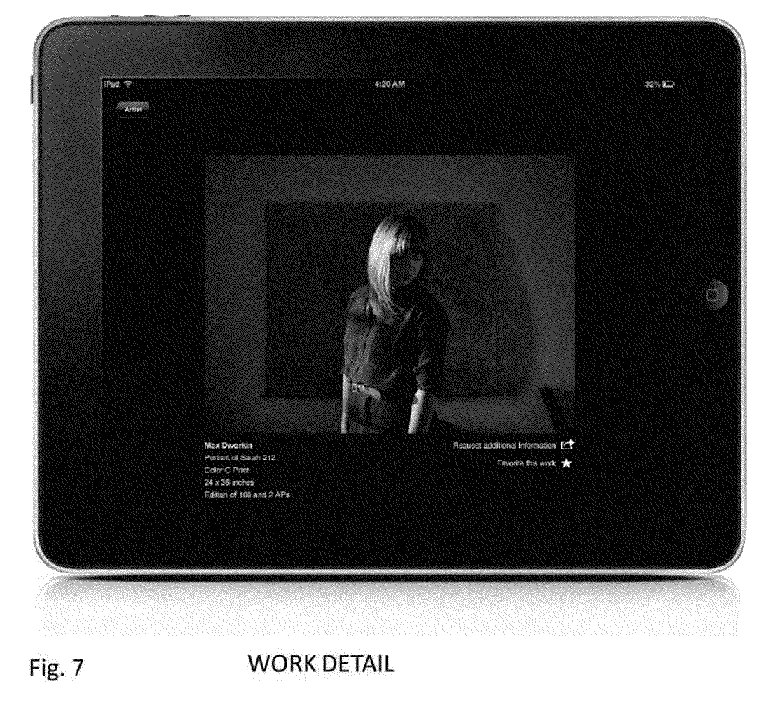

FIG. 7 illustrates an example mobile computing device (e.g., a tablet computer) and an example display screen provided in accordance with an embodiment of the present application. The example shown in FIG. 7 illustrates details associated with an example work of art. In the example, shown in FIG. 7, information is presented that shows an image of the artwork, the name of the artist, the title of the work, the size of the work, the edition of the work. Further, options are provided for requesting additional information and for selecting the work in a bin of “favorites.”

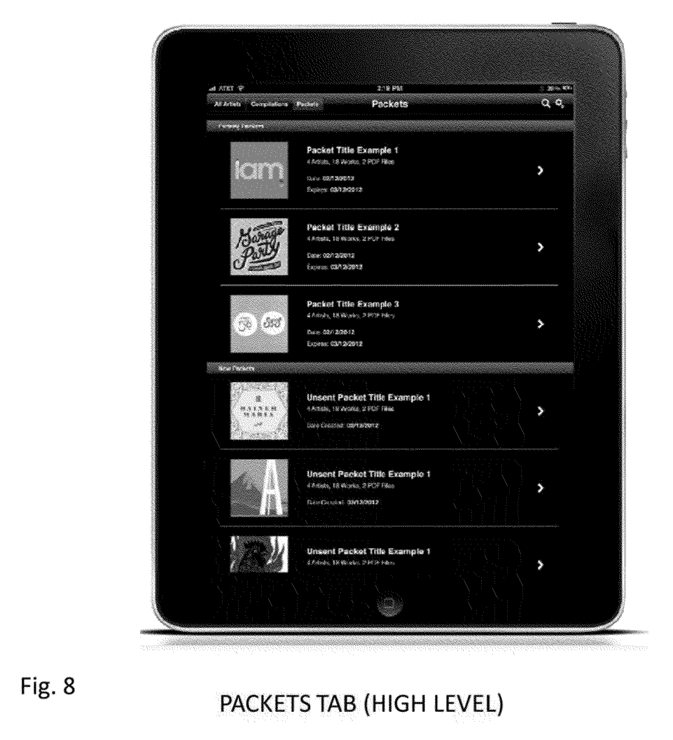

FIG. 8 illustrates an example mobile computing device (e.g., a tablet computer) and an example display screen provided in accordance with an embodiment of the present application. The example shown in FIG. 8 illustrates a high level view of various packets, and includes titles of the packets, thumbnail images representing the packets, dates, expiration dates, and shows the packets sorted in groups of previously existing packets and new packets. Further, selectable options are provided for accessing additional information in the packets.

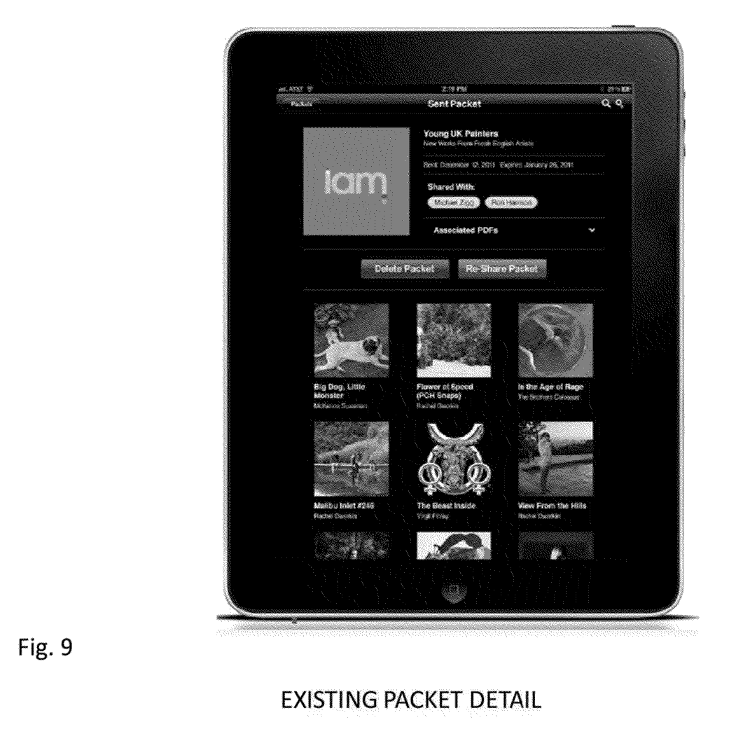

FIG. 9 illustrates an example mobile computing device (e.g., a tablet computer) and an example display screen provided in accordance with an embodiment of the present application. The example shown in FIG. 9 illustrates an example existing packet detail. The example packet shown in FIG. 9 includes options for deleting/sharing the packet, identifies with whom the packet has been shared, and includes thumbnail images, titles, artist names and other information representing the artwork compiled in the packet.

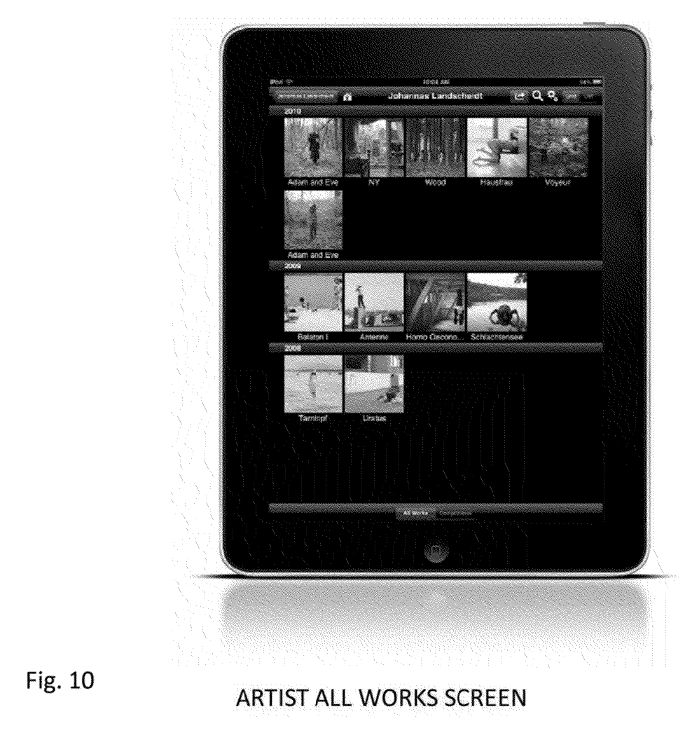

FIG. 10 illustrates an example mobile computing device (e.g., a tablet computer) and an example display screen provided in accordance with an embodiment of the present application. The example shown in FIG. 10 illustrates an example artist all works screen, and includes thumbnail images associated with a selected artist. The artwork shown in FIG. 10 is sorted in descending order by year, and includes thumbnail images of the artwork and titles. Moreover, selectable options are provided for all works of the artist, or to view particular selected compilations of the artist.

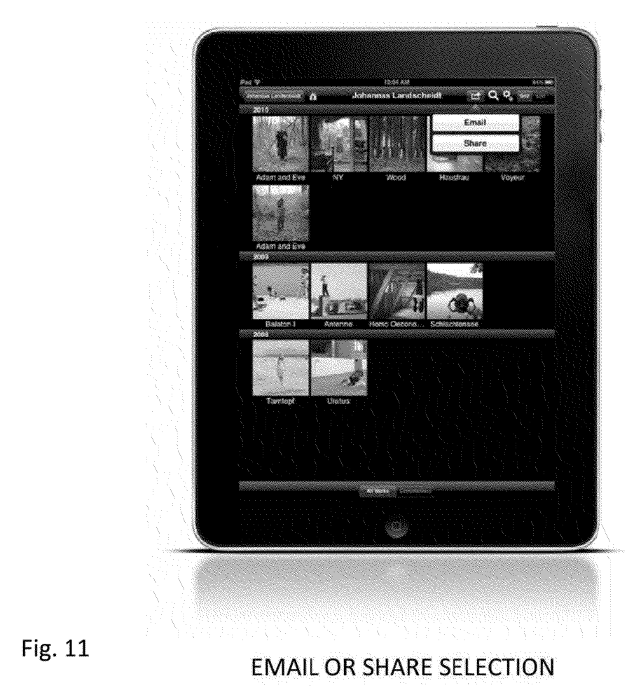

FIG. 11 illustrates an example mobile computing device (e.g., a tablet computer) and an example display screen provided in accordance with an embodiment of the present application. The example shown in FIG. 11 illustrates the artist works display screen shown in FIG. 10, and includes additional functionality for emailing or otherwise sharing the artist's work.

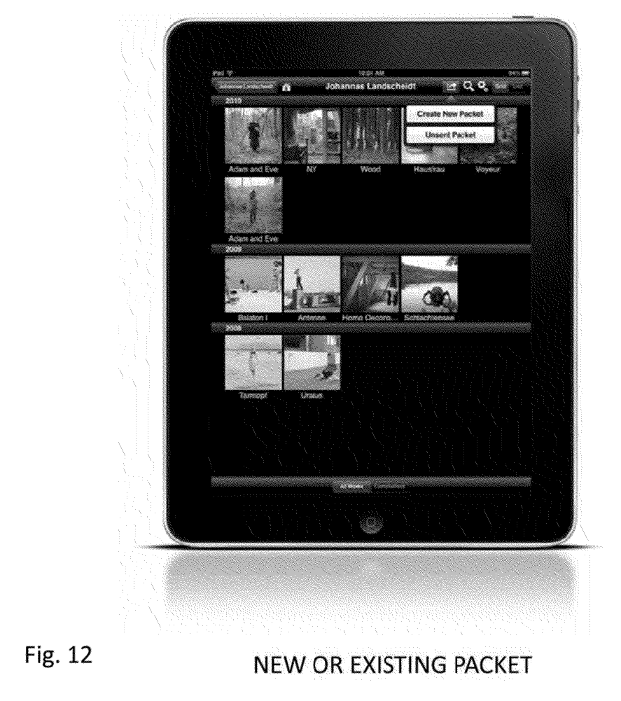

FIG. 12 illustrates an example mobile computing device (e.g., a tablet computer) and an example display screen provided in accordance with an embodiment of the present application. The example shown in FIG. 12 illustrates the artist works display screen shown in FIG. 10, and includes additional functionality for creating or selecting an existing packet. In the example shown in FIG. 12, an option is provided for selecting an “unsent” packet, which has not been emailed or otherwise shared by the user.

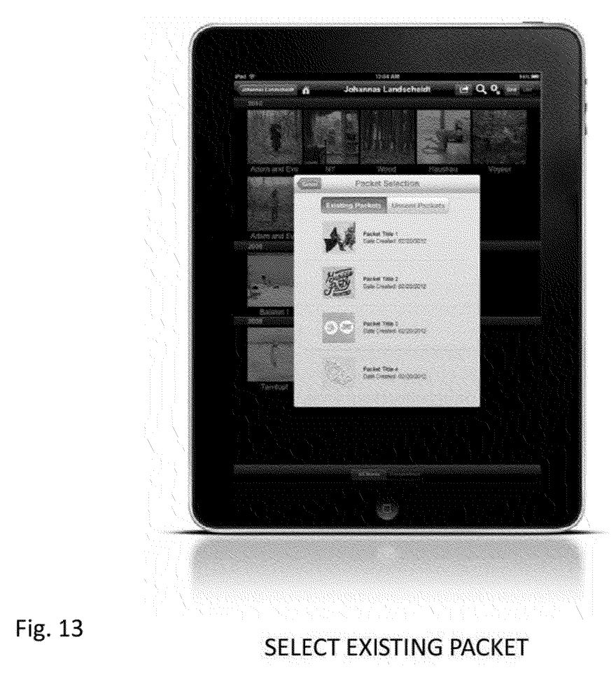

FIG. 13 illustrates an example mobile computing device (e.g., a tablet computer) and an example display screen provided in accordance with an embodiment of the present application. The example shown in FIG. 13 illustrates an example existing packet selection display screen, and includes thumbnail views and corresponding information associated with packets that are existing and/or unsent.

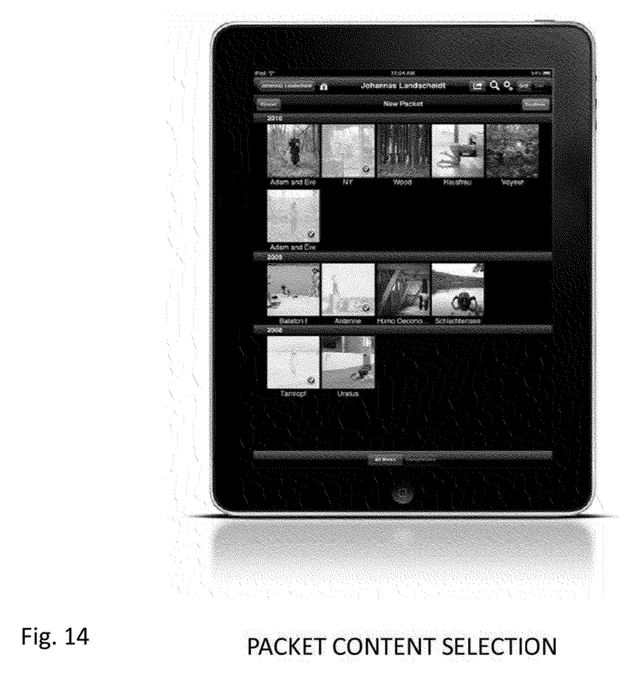

FIG. 14 illustrates an example mobile computing device (e.g., a tablet computer) and an example display screen provided in accordance with an embodiment of the present application. The example shown in FIG. 14 illustrates an example packet content selection display screen, and shows the artist works display screen shown in FIG. 10 and includes additional functionality for selecting particular work(s) for assembling into a new packet. In the example shown in FIG. 14, the user selects respective thumbnails of the work(s) and checkmark(s) appear to represent that the particular work is selected for the new packet.

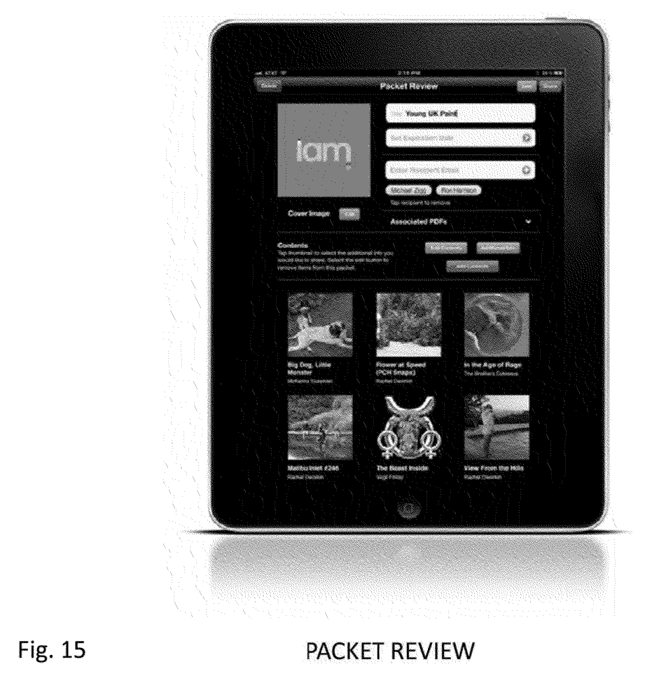

FIG. 15 illustrates an example mobile computing device (e.g., a tablet computer) and an example display screen provided in accordance with an embodiment of the present application. The example shown in FIG. 15 illustrates an example packet review and identifies the respective work(s) selected in FIG. 14 for the user's review. The example display screen shown in FIG. 15 includes similar information as shown and described above with regard to FIG. 9.

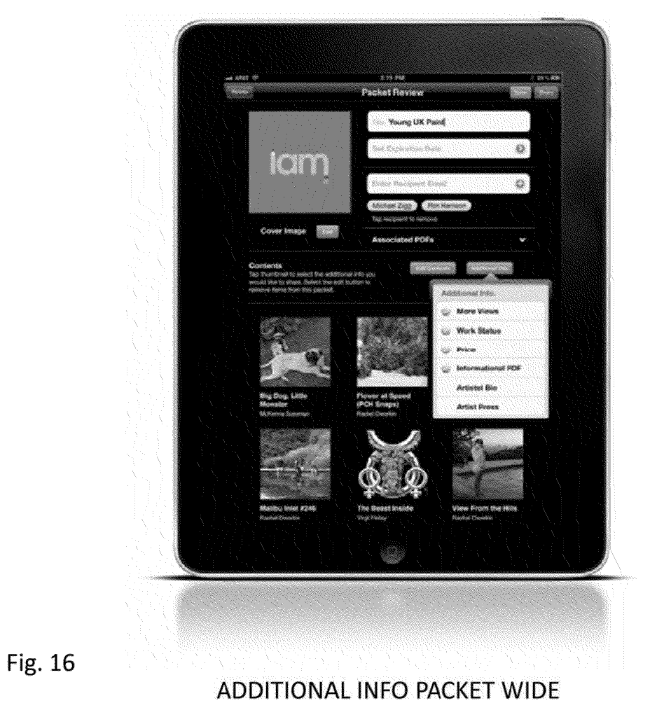

FIG. 16 illustrates an example mobile computing device (e.g., a tablet computer) and an example display screen provided in accordance with an embodiment of the present application. The example shown in FIG. 16 illustrates additional functionality for providing information associated with the packet illustrated in FIG. 15. In the example shown in FIG. 16, additional information may be provided for additional views of the work(s), status information of the work(s), price information, corresponding information file(s) (e.g., PDF files), artist biography information and press information associated with the artist.

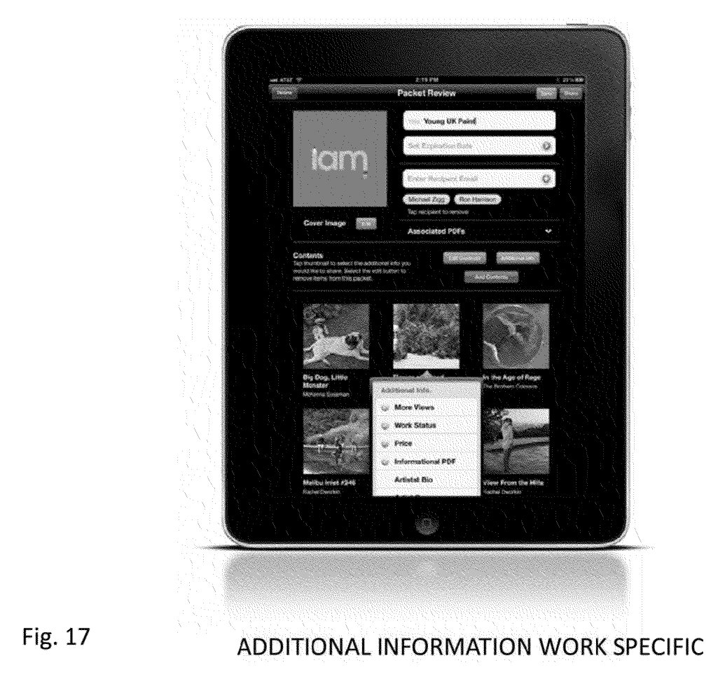

FIG. 17 illustrates an example mobile computing device (e.g., a tablet computer) and an example display screen provided in accordance with an embodiment of the present application. The example shown in FIG. 17 illustrates functionality for additional information that is provided for a specific piece of work included in the packet.

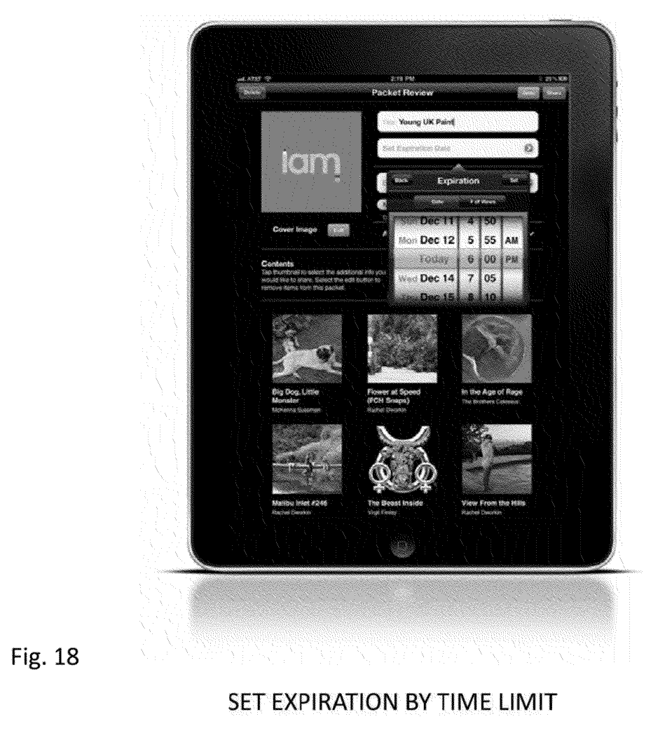

FIG. 18 illustrates an example mobile computing device (e.g., a tablet computer) and an example display screen provided in accordance with an embodiment of the present application. The example shown in FIG. 18 illustrates additional functionality for defining an expiration period by date and time. By defining expiration periods, the present application enables users to set finite periods when one or more packets are available for review by one or more other users.

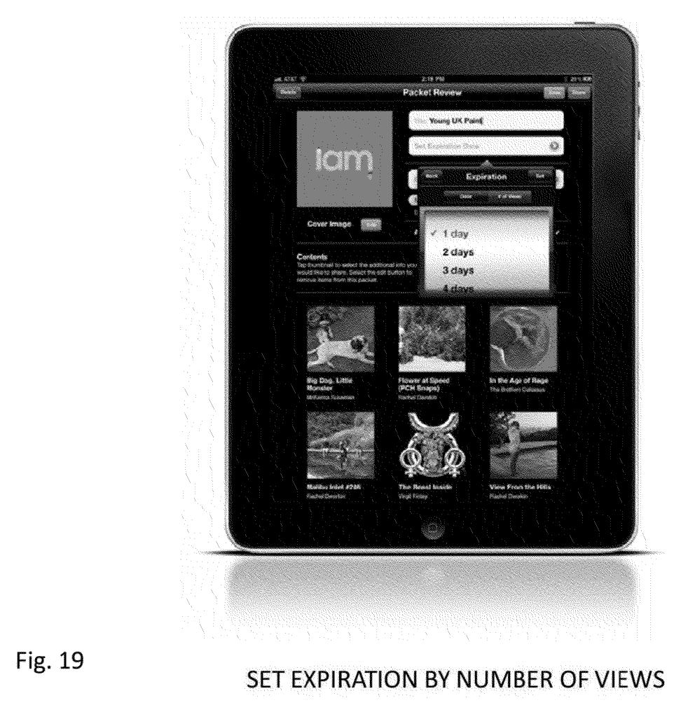

FIG. 19 illustrates an example mobile computing device (e.g., a tablet computer) and an example display screen provided in accordance with an embodiment of the present application. The example shown in FIG. 19 illustrates an example set expiration by number of views.

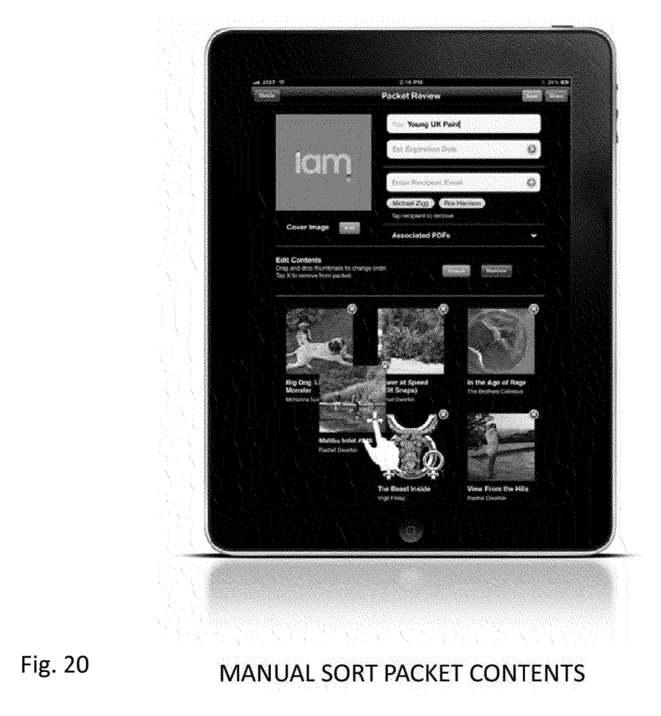

FIG. 20 illustrates an example mobile computing device (e.g., a tablet computer) and an example display screen provided in accordance with an embodiment of the present application. The example shown in FIG. 20 illustrates additional functionality for enabling the sorting packet contents. In the examples shown in FIG. 20, a user selects a thumbnail image representing a work of art, and drags the thumbnail image to a respective position within the other thumbnail images to sort the images according to personal preference.

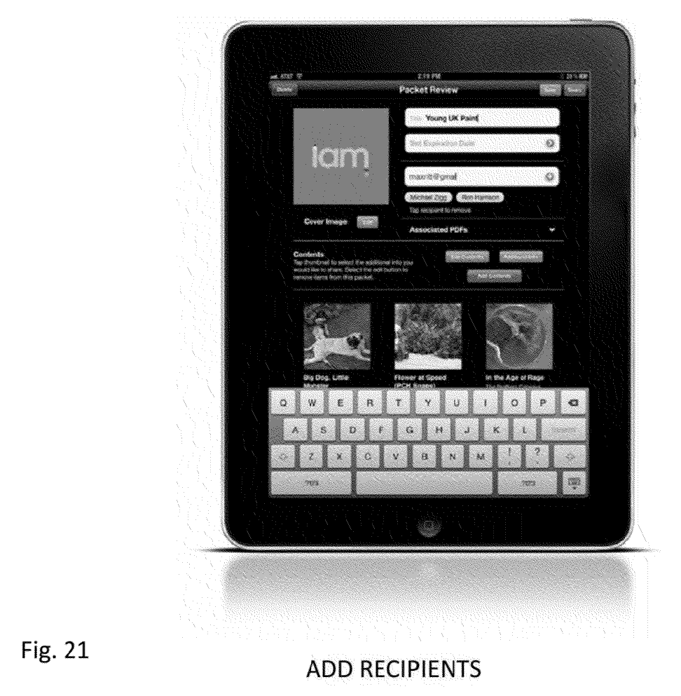

FIG. 21 illustrates an example mobile computing device (e.g., a tablet computer) and an example display screen provided in accordance with an embodiment of the present application. The example shown in FIG. 21 illustrates additional functionality for adding recipients to share a packet. In the example shown in FIG. 21, the user may type the name, email address and/or other contact information of a recipient.

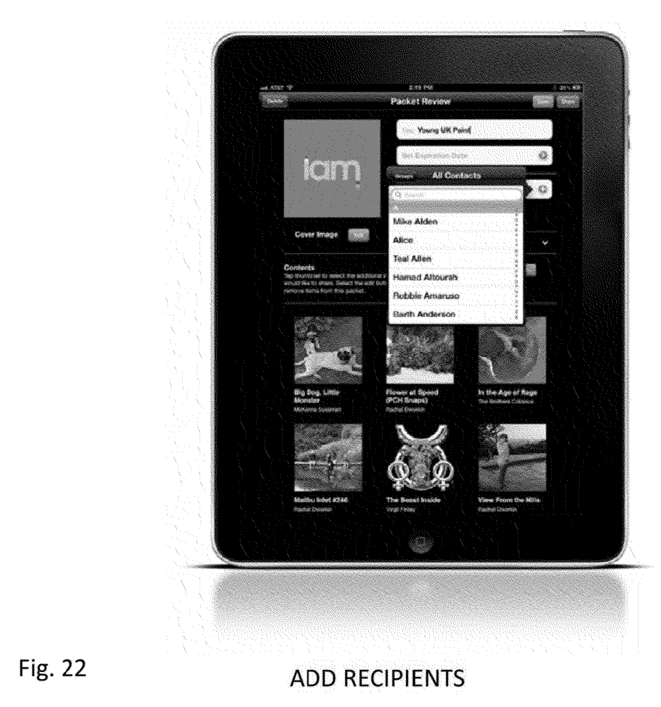

FIG. 22 illustrates an example mobile computing device (e.g., a tablet computer) and an example display screen provided in accordance with an embodiment of the present application. The example shown in FIG. 21 illustrates additional functionality for adding recipients to share a packet. In the example shown in FIG. 22, the user may access a contact list, such as an address book, and select a recipient for the packet.

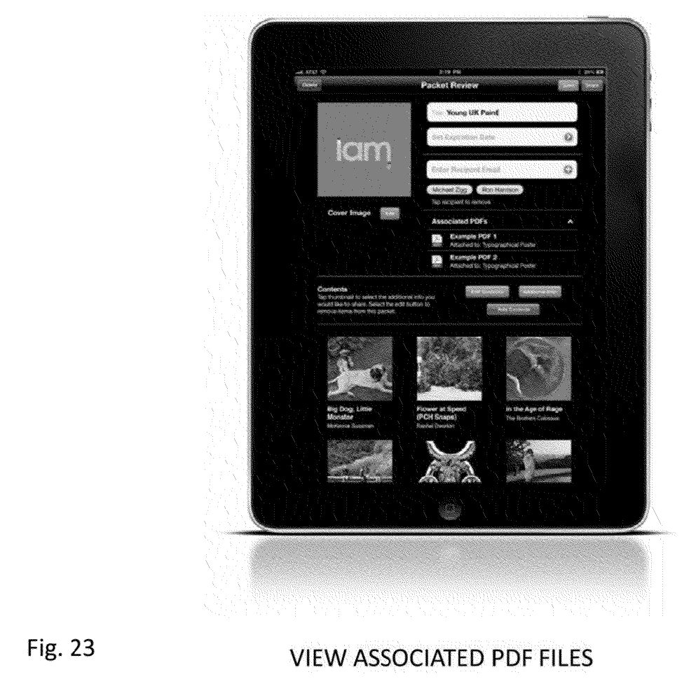

FIG. 23 illustrates an example mobile computing device (e.g., a tablet computer) and an example display screen provided in accordance with an embodiment of the present application. The example shown in FIG. 23 illustrates additional functionality for identifying one or more additional information files (e.g., PDF files) that the user would like included with the packet. In the example shown in FIG. 23, additional content may be added, and options are provided for customizing the appearance of the packet, such as the cover image representing the packet.

Thus, as shown and described herein, functionality is provided for selecting one or more representations of artwork into packets, and the packets may be shared and viewed using a convenient interface. FIG. 3C illustrates an example display screen in accordance with an embodiment of the present application, and includes a search feature allows the user to search the application using criteria such as artist, work and exhibition. The systems and methods shown and described herein improve communication between gallery owners, representatives, clients, artists and others, and conveniently provide multimedia content regarding, for example, artwork, artists and further supports for sending follow-up messages, such as emails, on the go. Users can share images and details of individual works directly from their mobile computing devices, and customizable settings are supported to enable users to quickly and easily select particular kinds of information to be included with an image. Information associated with provenance, price, dimensions, or the like can be selected, and in a particular display order. With just a few taps, a user can easily send an email with images and any selection of work details. Users can also create a customizable signature and attach PDFs of bios or press reviews.

In an embodiment, one or more information processors, which may include server computers, receive an inventory listing that is generated by a local computing system for a plurality of works. The works may be audio, visual or some combination thereof. In an embodiment, the inventory listing may include information for one or more individual works that is included in the plurality of works. Additionally, one or more images associated with the work(s) may be included in the inventory listing. A selection of at least a portion of the visual works is received, for example, from a mobile computing device, which may include information for each individual work for inclusion in a displayable compilation of the selected portion of the plurality of the visual works. Moreover, a command is received to publish the compilation to enable the compilation to be presented on one or more selected portable computing devices remote from the server computing system. In an embodiment, the inventory listing is in the form of a spreadsheet that is exportable from a visual works inventory management system. Moreover, the information representing each individual visual work may be included in the plurality of visual works and may include one or more of a name of an artist creating each individual visual work, a title of each individual visual work, and an inventory identifier of each individual visual work.

In one or more embodiments, the information representing the plurality of visual works further includes each individual visual work, one or more of dimensions of each individual visual work, a year of creation of each individual visual work, a price of each individual visual work, and an availability for purchase of each individual visual work. Moreover, instructions may be received for supplementary information to be associated with one or more of each of the plurality of visual works. The supplementary information may include one or more of biographical information of the artist creating the work(s), as well as press information relating to the artist(s) and the visual work(s).

Further, a search may be provided for inventory listings based on parameter(s) to facilitate the selection of the at least a portion of the plurality of the visual works and the information for each individual work for inclusion in a compilation that can be displayed on a portable computing device. Upon receiving the information representing the plurality of visual works, verification of the information representing the works is provided, and the inventory listing can be secured to a particular account, and the server computer may maintain a plurality of inventory listings for a plurality of accounts. The accounts are secured to authenticated users.

In an embodiment, a command may be received to unpublish the compilation, while maintaining the compilation on the server for subsequent publication, and the server may be accessible via the Internet using a uniform resource locator.

In an embodiment, a portable computing system is configured to access a displayable compilation published for access by the portable computing system, wherein the compilation may include information for each individual visual work included in the compilation and one or more images of each individual visual work may be included in the compilation. Further, the computing device may send and/or receive commands for the selective display of information for each individual work included in the compilation.

Furthermore, the system may be restricted to allow only an authorized user to enter commands enabling the selective display of information, while other users may be allowed to access the information. The selective display of information enabled by the authorized user may include displaying and/or suppressing a price of each individual visual work included in the displayable compilation. Further, a search of the compilation may be enabled according to one or more parameters relating to one or more individual visual works included in the displayable compilation. Each of the parameter(s) may include a name of an artist creating each individual visual work, a title of each individual visual work, an inventory identifier of each individual visual work, dimensions of each individual visual work, a year of creation of each individual visual work, a price of each individual visual work, and an availability for purchase of each individual visual work. Moreover, the portable computing system may access the server computing system via wireless communications with an Internet.

In yet another embodiment, a server computing system presents an inventory listing generated by a local computing system for one or more visual works. The inventory listing may include information for each of the individual visual work(s) and one or more images of each of the work(s). A selection of at least a portion of the work(s) is presented, and information for each individual work for inclusion in a compilation. A command to publish the compilation is provided to enable the compilation to be presented on one or more portable computing devices that may be remote from the server computing system. The portable computing system is configured to access a compilation published for access, and commands may be received for enabling display of the information for each individual work included in the compilation.

The inventory listing may be in the form of a spreadsheet that is exportable from a visual works inventory management system. Moreover, the information representing each individual visual work included in the work(s) may include a name of an artist creating each individual visual work, a title of each individual visual work, and/or an inventory identifier of each individual visual work. Further, the information representing the work(s) may include, for each individual work, dimensions of each individual visual work, a year of creation of each individual visual work, a price of each individual visual work, and/or availability for purchase of each individual visual work.

In an embodiment, the server computing system may provide supplementary information to be associated with one or more of the visual work(s). The supplementary information may include one or more of biographical information of the artist creating at least one of the visual work(s), as well as press information relating to the artist and/or the work(s). The server computing system may present a search of the inventory listing by one or more parameters. The search may be received from a portable computing device, and may facilitate the selection of the at least a portion of the plurality of the visual works and the information for each individual work for inclusion in a compilation. Upon receiving the information representing the visual work(s), verification of the information representing the works may be provided at the server computing system via the local computing system. Furthermore, a user of the local computing system may be provided to secure the inventory listing to a particular account at the server computing system such that only a user authenticated to access the inventory listing of the particular account is enabled access to the inventory listing of the particular account.

Further, a command may be presented at the server computing system via the local computing system to unpublish the displayable compilation while maintaining the compilation on the server computing system for subsequent publication.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A non-transitory computer-readable storage medium storing instructions executable by a computer system, the non-transitory computer-readable storage medium comprising instructions to:
at a server computing system:
receive an inventory listing generated by a local computing system for a plurality of visual works, wherein the inventory listing includes information for each individual visual work included in the plurality of visual works and one or more images of each individual work;
receive a selection of at least a portion of the plurality of the visual works and information for each individual work for inclusion in a displayable compilation of the selected portion of the plurality of the visual works; and
publish the displayable compilation to enable the displayable compilation to be presented on one or more selected portable computing devices remote from the server computing system.

2. The non-transitory computer-readable storage medium of claim 1, wherein the inventory listing is in the form of a spreadsheet exportable from a visual works inventory management system.

3. The non-transitory computer-readable storage medium of claim 1, wherein the information representing each individual visual work included in the plurality of visual works includes a name of an artist creating each individual visual work, a title of each individual visual work, and an inventory identifier of each individual visual work.

4. The non-transitory computer-readable storage medium of claim 3, wherein the information representing the plurality of visual works further includes for each individual visual work one or more of dimensions of each individual visual work, a year of creation of each individual visual work, a price of each individual visual work, and an availability for purchase of each individual visual work.

5. The non-transitory computer-readable storage medium of claim 3, further comprising instructions to receive supplementary information to be associated with one or more of each of the plurality of visual works.

6. The non-transitory computer-readable storage medium of claim 5, wherein the supplementary information includes one or more of biographical information of the artist creating one or more of the plurality of visual works and press information relating to one of the artist and one or more of the plurality of visual works.

7. The non-transitory computer-readable storage medium of claim 1, further comprising instructions to enable a search of the inventory listing by one or more parameters to facilitate the selection of the at least a portion of the plurality of the visual works and the information for each individual work for inclusion in a displayable compilation.

8. The non-transitory computer-readable storage medium of claim 1, further comprising instructions to, upon receiving the information representing the plurality of visual works, enabling verification of the information representing the plurality of visual works.

9. The non-transitory computer-readable storage medium of claim 1, further comprising instructions to secure the inventory listing to a particular account, wherein the server computing system may maintain a plurality of inventory listings for a plurality of accounts, and wherein only a user authenticated to access the inventory listing of the particular account is enabled access to the inventory listing of the particular account.

10. The non-transitory computer-readable storage medium of claim 1, further comprising instructions to receive a command to delete the displayable compilation while maintaining the displayable compilation on the server computing system for subsequent publication.

11. The non-transitory computer-readable storage medium of claim 1, wherein the server computing system is accessible via an Internet using a uniform resource locator.

12. A non-transitory computer-readable storage medium storing instructions executable by a computer system, the non-transitory computer-readable storage medium comprising instructions to:
at a portable computing system:
access a displayable compilation published for access by the portable computing system at a server computing system, wherein the displayable compilation includes information for each individual visual work included in the displayable compilation and one or more images of each individual visual work included in the displayable compilation; and
selectively display the information for each individual work included in the displayable compilation.

13. The non-transitory computer-readable storage medium of claim 12, further comprising instructions to enable only an authorized user to enter commands enabling the selective display of information, wherein other users are able to access the information selectively enabled for display by the authorized user.

14. The non-transitory computer-readable storage medium of claim 13, wherein the selective display of information enabled by the authorized user may include one of displaying and suppressing a price of each individual visual work included in the displayable compilation.

15. The non-transitory computer-readable storage medium of claim 12, further comprising instructions to enable a search of the displayable compilation according to one or more parameters relating to one or more individual visual works included in the displayable compilation.

16. The non-transitory computer-readable storage medium of claim 15, wherein each of the one or more parameters includes a name of an artist creating each individual visual work, a title of each individual visual work, an inventory identifier of each individual visual work, dimensions of each individual visual work, a year of creation of each individual visual work, a price of each individual visual work, and an availability for purchase of each individual visual work.

17. The non-transitory computer-readable storage medium of claim 12, wherein the portable computing system accesses the server computing system via wireless communications with an Internet.

18. A computer-implemented method, comprising:
at a server computing system via a local computing system:
presenting an inventory listing generated by a local computing system for a plurality of visual works, wherein the inventory listing includes information for each individual visual work included in the plurality of visual works and one or more images of each individual work;
presenting a selection of at least a portion of the plurality of the visual works and information for each individual work for inclusion in a displayable compilation of the selected portion of the plurality of the visual works; and
presenting a command to publish the displayable compilation to enable the displayable compilation to be presented on one or more selected portable computing devices remote from the server computing system; and
at a portable computing system:
accessing a displayable compilation published for access by the portable computing system at the server computing system; and
selective displaying of the information for each individual work included in the displayable compilation.

19. The computer-implemented method of claim 18, wherein the inventory listing is in the form of a spreadsheet exportable from a visual works inventory management system.

20. The computer-implemented method of claim 18, wherein the information representing each individual visual work included in the plurality of visual works includes a name of an artist creating each individual visual work, a title of each individual visual work, and an inventory identifier of each individual visual work.
